(19) United States
(12) Patent Application Publication
(10) Pub. No.: US 2025/0055883 A1
(43) Pub. Date: Feb. 13, 2025

(54) A METHOD FOR MONITORING OR VALIDATING COMPLIANCE OF A DEVICE ON A NETWORK

(71) Applicant: BRITISH TELECOMMUNICATIONS PUBLIC LIMITED COMPANY, LONDON (GB)

(72) Inventors: Jonathan ROSCOE, London (GB); Fadi EL-MOUSSA, London (GB)

(21) Appl. No.: 18/720,144

(22) PCT Filed: Nov. 23, 2022
(86) PCT No.: PCT/EP2022/083013

§ 371 Date: Jun. 14, 2024

(30) Foreign Application Priority Data
Dec. 22, 2021 (GB) 2118772.9

(51) Int. Cl. H04L 9/40

(52) U.S. Cl. CPC H04L 63/20; H04L 63/10

(57) ABSTRACT

A method for monitoring or validating compliance of the attributes of a device (709) on a network (703), the method including: obtaining, from a distributed ledger technology (701), a first tree data structure including compliance data associated with a network-(703), and a second tree data structure comprising attribute data associated with an electronic device (709); comparing the first tree data structure (705) with the second tree data structure to compare the compliance data with the attribute data; and determining, based on the comparison, whether the electronic device (709) is compliant with the network (703).

### PRIORITY CLAIM

The present application is a National Phase entry of PCT Application No. PCT/EP2022/083013, filed Nov. 23, 2022, which claims priority from GB Application No. 2118772.9, filed Dec. 22, 2021, each of which hereby fully incorporated herein by reference.

### TECHNICAL FIELD

The present disclosure relates to a method for monitoring or validating compliance of a device on a network, and in particular compliance of attributes of a device on a network using distributed ledger technology. The present disclosure also relates to a computer system for monitoring or validating compliance of attributes of a device on a network.

### BACKGROUND

The proliferation of Internet of Things (IoT) devices in recent years has led to countless vendors offering a variety of devices for scenarios such as environmental control, health monitoring, surveillance, multimedia, interaction, logistics and more.

Due to the computational and power constraints of such devices, security (which relies on cryptographic methods known for their high computational cost) is often a secondary concern. Thus, network owners who allow such devices onto their network expose themselves to new risks.

This is exacerbated when the transient nature of IoT devices is considered, and network operators may wish to allow access to their network to facilitate the operations of suppliers and customers. Devices may cross many networks and networks may contain devices for a variety of vendors.

Similar issues have been seen elsewhere, such as email, where many organizations must cooperate to maintain secure infrastructure when propagating messages between themselves. In relation to email, the Domain-based Message Authentication, Reporting, and Conformance (DMARC), allows organizations to establish policies with regards to mail handling. DMARC allows organizations to publish a security policy that specifies acceptable authentication mechanisms as well as how others should interact with the organization and treat mail routed to/from the organization.

Organizations, and particularly large organizations may have a lot of assets such as computer devices, machines, IoT devices, servers, and routers. Each asset typically has to follow or comply with specific security policies based on an organization's security policy. The administration of compliance of many assets can prove challenging.

### SUMMARY

The inventors of the embodiments described herein have appreciated the need for a system capable of monitoring or validating whether a device attempting to connect to a network, or that is already in connection with a network, complies with network security policies. In particular, the inventors have appreciated the need to be able to manage the compliance of many devices across a plurality of networks.

Arrangements of the present disclosure provide a tree data structure having a probabilistic data structure, such as a bloom tree, as a probabilistic data store of device information which can be used to monitor or validate compliance of attributes of a device on a network, such as an entity or organization network. Arrangements also include publishing said tree data structures on a distributed ledger technology such as the blockchain ecosystem, allowing for convenient distribution and comparison of the tree data structures to monitor or validate compliance on a network and provide automatic analysis and management of devices.

A tree data structure may be used to build a description of attributes of a device such as an electronic device, and a counterpart tree data structure may be used to build a description of attributes, policies, or parameters accepted by a network. The tree data structure of the electronic device, or second tree data structure, may be considered a descriptor of a device's software and hardware configuration. The tree data structures may be termed compliance trees. The two tree data structures may be conveniently compared to establish if the device described by the second tree data structure will be compliant with policies or security of a network described by the tree data structure of the network (or first tree data structure). Network owners such as an organization, enterprise, or entity can use the tree structures as a means of verifying candidate devices before they are permitted within a network.

A device vendor may develop a device with a particular configuration. The device may broadcast its tree data structure on a network it wishes to access. Any relevant party such as a network owner organization, service provider, or network provider may then perform an assessment of that tree data structure to determine whether or not the device wishing to access the network has attributes complying with the relevant security standards or policies of the network.

The attribute data associated with the electronic device may comprise one or more hardware and/or software attributes. Each node of the second tree data structure may represent an attribute of the electronic device. The compliance data associated with the network may comprise one or more hardware and/or software attributes. Each node of the first tree data structure may represent an attribute accepted by the network. The attributes may include, for example: device type, operating system, operating system version, kernel information, firewall policy, network connectivity, and applications.

The first and second tree data structures may be first and second Merkle trees respectively. Each of the first and second Merkle trees may comprise a plurality of nodes, and each node of the plurality of nodes may have an associated hash generated based on the nodes beneath it. A Merkle tree is a binary tree in which all leaf nodes are associated with a cryptographic hash, and all non-leaf nodes are associated with a cryptographic hash that is formed from the hashes of its child nodes. Each hash in a Merkle tree is different. The hashes may be used to evaluate or compare particular attributes associated with the hashes in the first and second tree data structures. To verify the presence of an element or hash in the Merkle tree, a series of hashes may be provided that when hashed with the element hash, recreate the hash of the Merkle root.

Merkle trees may be used as a mechanism for storing device information. This enables fast and efficient evaluation of compliance as well as the ability to search for devices and related data on a network, which provides an efficient mechanism for managing networks having a plurality of devices such as an Internet of Things (IoT) sensor network.

Performing a comparison of the first and second tree data structures may comprise comparing the hashes in the second Merkle tree with the hashes in the first Merkle tree to determine if the hashes in the second Merkle tree are present in the first Merkle tree. In some embodiments, if it is determined that a hash is present in the second Merkle tree that is not present in the first Merkle tree, the electronic device may be determined as being non-compliant with the network. The presence of a hash in the second Merkle tree of the device's compliance tree denotes or indicates the presence of an attribute of the device that is not accepted by the network, for example because it is an attribute not in line with security policy of the entity or organization. For example, the electronic device may be running a particular kernel version that is not accepted by the network due to its susceptibility to malware.

An evaluation mechanism may be used in combination with the Merkle tree to evaluate compliance between a device and a network which may be particularly advantageous in a multi-component system. The evaluation mechanism may be any suitable evaluation mechanism capable of evaluating the presence or absence of one or more hashes associated with the plurality of nodes. In other words, the evaluation mechanism may be used as a mechanism for assessing compliance of attributes of a device on a network by comparing tree fragments which may be fragments or portions of the tree data structures. The evaluation mechanism may determine that the second tree data structure comprises a hash not present in the first tree data structure. If this is determined, in some embodiments, the electronic device may be determined as being non-compliant with the network.

The evaluation mechanism may include, for example, bloom filters, aggregated hashes, or tree structures. Implementation of tree structures may include use of graph theoretic algorithms, for example, to check for equality between fragments of a graph. This may include determining whether one graph (the compliance tree of the device) is a subset or fragment of another graph (the network tree).

Bloom filters may be described as probabilistic data structures and are particularly space-efficient probabilistic data structures. Bloom filters essentially summarize data in a set, and can verify if an element or not in a set. Bloom filters can answer the question “is element x in set S?” with either “maybe” or “definitely not”. In blockchain applications they have traditionally been used in the underlying peer-to-peer network in order to connect to peers who may be in possession of desired data (i.e. blocks for synchronization). Generally, bloom filters help reduce a large search space quickly by verifying the absence of a data point in a set.

The first and second tree data structures may each comprise one or more probabilistic data structures for evaluating the presence or absence of one or more hashes associated with the plurality of nodes, and the probabilistic data structures may be used to evaluate the presence or absence of one or more hashes.

A bloom filter is a bit vector built from a group of cryptographic hashes of a data set. A bloom tree uses the same concept, but each node of the tree data structure comprises a bloom filter for the nodes below it in the tree data structure.

Specifically, a bloom tree is a probabilistic data structure that combines the idea of bloom filters with Merkle trees. Where the first and second data trees comprise probabilistic data structures in the form of bloom filters, the first and second data trees may be bloom trees. The first and second tree data structures may comprise a plurality of probabilistic data structures, for example a plurality of bloom filters. Each node of the tree data structure may comprise a bloom filter for the nodes below it.

The nodes of the first tree data structure may represent all possible attributes of the compliance data accepted by the network. The probabilistic data structures may be used to evaluate all possible accepted attributes by evaluating all possible accepted hashes of the tree data structure. The probabilistic data structure, which may comprise a bloom filter, may be considered a list of the attributes compliant with the network.

A tree data structure may refer to a full data structure or a fragment or sub portion of a full data structure. Similarly, the comparison of tree data structures may refer to a comparison of full tree data structures, fragments of full data structures, or any combination of the two. It may be determined that a tree data structure is not compliant. It may also be determined that multiple fragments or sub portions of trees are not compliant. One or more fragments of full tree data structures may be compared with one or more fragments of tree data structures. A fragment may comprise software attributes and another fragment may comprise hardware attributes.

In some embodiments, the second tree data structure may be provided by the associated electronic device. That is, the second tree data structure, or the compliance tree, is self-reported by the electronic device. The manufacturer of the device may provide usage description files and an associated device may announce its descriptor including attributes and capabilities to relevant parties when attempting to access a network.

Tree data structures are built for devices typically based on their attributes, and manufacturers may be typically expected to expose the trees (or hashes of the parent node of the tree data structure describing a device). However, in some embodiments this may not be possible. It may therefore be possible and indeed advantageous to build a tree data structure for a device when the tree data structure or hash of the parent node is not provided, or in other words, a device lacks transparency regarding its attributes. Such a device may be a “black box” system which may be associated with a third-party where other mechanisms to build the tree data structure are not possible.

Therefore, in some embodiments, the electronic device may be interrogated to determine the attribute data, and the second tree data structure may be formed based on the determined attribute data. The interrogating may comprise using signature analysis to construct a tree data structure. Signature detection can be used to identify specific software components. The interrogation may non-exhaustively comprise one or more of: a HTTP query, SSH query, a port scan, network port mapping, or a ping test. The results of the interrogation can then be used to build the tree data structure based on the attributes of the device determined by the interrogation. A comparison may then be made with the network's tree data structure in the manner described above to monitor or validate compliance with the network.

Bloom trees allow for quick and easy comparison of prospective devices. This allows an enterprise to compare its own compliance trees with potential candidates.

Information about devices and/or networks such as attribute data and/or compliance data may be shared, for example, on the blockchain ecosystem. In this way, up to date device and network information may be conveniently published and maintained in a way that is accessible for convenient comparison in order to validate or monitor device compliance on a network.

According to an aspect of the present disclosure, there is provided a method for monitoring or validating compliance of the attributes of a device on a network, the method comprising: obtaining, from a distributed ledger technology, a first tree data structure comprising compliance data associated with a network, and a second tree data structure comprising attribute data associated with an electronic device; comparing the first tree data structure with the second tree data structure to compare the compliance data with the attribute data; and determining, based on the comparison, whether the electronic device is compliant with the network.

In other words, a blueprint for a network belonging to organization, along with blueprints for electronic devices, can be published on or registered to a digital ledger technology such as a blockchain database. That is, the digital ledger technology may comprise a blockchain database, and the obtaining the first and second tree data structures may comprise accessing a set of transactions corresponding to the first and second tree data structures from the blockchain database. The blockchain database will be used as an example, but it will be appreciated that any suitable digital ledger technology may be applicable. Blockchain may be particularly advantageous in a multi-vendor, multi-user ecosystem.

Whilst a single first tree data structure and a single second tree data structure have been described, it will be appreciated that the method may be applicable to a plurality of first tree data structures relating to different networks, and/or a plurality of second tree data structures relating to different devices. Appropriate comparisons may then be made between relevant tree data structures associated with electronic devices with relevant tree data structures associated with networks in order to determine compliance.

By publishing or registering blueprints or compliance trees for both networks as well as electronic devices that may wish to access the network, a conveniently accessible store of up to date information is provided. In doing so, a network, or computer system of a network, may efficiently assess attributes of a device to determine compliance with the network and continually monitor the compliance of devices already connected to the network. This may be particularly advantageous in a system with a plurality of devices as each device may be conveniently validated or monitored potentially across a plurality of networks, with all information being stored within the blockchain database.

Within the distributed ledger technology or distributed ledger system, there may be maintained a record of compliance trees or tree data structures related to the networks of one or more network owners such as organizations or enterprises. Each compliance tree related to a network may define different compliance data and thus different security policies and requirements. The distributed ledger may also comprise details of each network owner.

In addition, within the distributed ledger technology, there may be registered a plurality of tree data structures associated with a plurality of electronic devices. Each of these tree data structures may also be different, corresponding to attribute data of the electronic devices describing differing attributes between different devices.

The network owner such as an organization may provide its own network compliance tree directly to the distributed ledger system. The network owner may provide, define, and update their policies and therefore their compliance tree, as well as policies for handling a device found to be non-compliant. The first tree data structure may be registered with the blockchain database, for example by an owner of the network. The registering may comprise typical publishing of information on the blockchain database. This may comprise creating a block in the blockchain database which may comprise a block hash and a root hash value of the first tree data structure. A network owner may be any applicable entity, organization, individual, or computer system associated with the network.

Similarly, the second tree data structure may be registered with the blockchain database by the electronic device by creating a block in the blockchain database comprising a block hash and a root hash value of the second tree data structure. The electronic device may register its tree data structure to the blockchain database, for example, when it wishes to access a network. The electronic device may be prompted to do so by the network, or a computer system on the network.

Having registered its tree data structure with the distributed ledger, the electronic device may attempt to demonstrate its compliance with the policy of the network through comparison of its tree data structure with the tree data structure associated with the network. This comparison may be made in response to the electronic device's request to access the network, or may be made in response to the electronic device registering its tree data structure. A comparison may also be made with a device already connected to the network to monitor continued compliance with the network.

The comparison may be made in the manner set out above, with the tree data structures being stored, accessed, and obtained from the distributed ledger system. That is, the tree data structures may comprise any of Merkle trees, probabilistic data structures such as bloom filters, and bloom trees as described, and determination of compliance may be made as described previously. When the electronic device registered with the blockchain database, it may sign against the hashes in the network's compliance tree which match the hashes in the device's tree, thus demonstrating which hashes or features are present. The comparing the first tree with the second tree may comprise evaluating which hashes the electronic device has signed against when registering with the blockchain database.

The attribute data and the compliance data may comprise attributes. That is, the attribute data may comprise attributes associated with the electronic device, and the compliance data may comprise a list of attributes considered compliant by the network policy. In some embodiments, the comparison of the first and second tree data structures comprises comparing the attributes of the attribute data and the compliance data, and if the comparison determines that the attribute data (or electronic device) comprises one or more attributes not in the compliance data (considered compliant by the network policy), it may be determined that the electronic device is not compliant with the network. In other words, the electronic device having an attribute not in the compliance data may indicate that the device is non-compliant.

In some embodiments, if an electronic device is determined to be not compliant with the network, the method may further comprise isolating the electronic device and determining if mitigation of the one or more attributes not in the compliance data is possible. The method may also comprise: if mitigation is possible, attempting mitigation of the one or more attributes not in the compliance data; or if mitigation is not possible, continuing to isolate the electronic device and preventing the electronic device from accessing the network. The prevention from accessing the network may be permanent or it may be temporary. Mitigation may be performed by the network, or a computer system on the network, for example, by adjusting a firewall or port access to account for the attribute not in the compliance data.

After attempting mitigation, if mitigation was unsuccessful, the method may comprise determining if further mitigation is possible, and if not, continuing to isolate the electronic device and preventing the electronic device from accessing the network. That is, an iterative process may be formed in which mitigation is constantly attempted until successful, or until mitigation attempts are not possible. When the electronic device is isolated, the method may further comprise the electronic device attempting to reconfigure to remediate the one or more attributes not in the compliance data. For example, where the electronic device is running on a particular software version that is not in the compliance data, the electronic device may update its software version to a software version in the compliance data that is considered compliant by the network.

The network, or a computer system on the network, may also instruct the electronic device to perform one or more actions to mitigate the one or more attributes not in the compliance data.

If the electronic device's attempt to reconfigure remediates the one or more attributes not in the compliance data, the method may further comprise granting the electronic device access to the network; and if the attempt to reconfigure does not remediate the one or more attributes not in the compliance data, the method may further comprise determining that the device is not compliant with the network. If mitigation of the one or more attributes not in the compliance data is successful, the method may further comprise granting the electronic device access to the network.

Reattempts at mitigation or remediation may be continuously made, or the electronic device may be removed from isolation and denied access to the network after, for example, a predetermined number of attempts or after a predetermined time.

In some embodiments, one or more of the attributes of the compliance data may be designated as essential. The compliance data comprises attributes considered compliant with the network, but in previously described embodiments, the electronic device need only have a subset of the attributes to be granted access to the network. However, one or more of the attributes compliant with the network security policy may be required. That is, in order to be granted access to the network, the attribute data of an electronic device must comprise the one or more essential attributes. If the comparison determines that the attribute data does not comprise one or more of the essential attributes, the method may comprise determining that the electronic device is not compliant with the network.

In some embodiments, once an electronic device registers its tree data structure to the blockchain database, it may continue to send data such as telemetry data to servers in the computer system. In this way, the blockchain database may be updated to account for any changes in traits or features of the electronic device reported by the electronic device.

In some embodiments, the method may further comprise: updating the first and/or second tree data structures to provide updated compliance and/or attribute data respectively: updating the distributed ledger technology with the updated compliance and/or attribute data; and performing a further comparison of the first tree data structure with the second tree data structure. Changes may be made to one or both of the first and second tree data structures. For example, an update in security policy may prompt an update in the first tree data structure. Alternatively or in addition, a change to a device attribute (such as an operating system update) may prompt an update to the second tree data structure. Such updates are provided to the blockchain database to ensure up to date information is stored in the database. If an update to one or both of the trees occurs, a further comparison may be made to validate compliance of a device with the network. For example, a device previously validated and granted access to the network may be re-evaluated to ensure it continues to comply with network policy. A further comparison may be prompted by the update of one or both of the first and second tree data structures. Nodes having associated hashes may be added or removed as appropriate from one or both of the first or second tree data structures responsive to updates.

A network owner may also wish to update or change its security policy, thus changing the compliance data and the tree data structure stored on the blockchain database. This may be prompted, for example, where a third party such as a security provider becomes aware of a security vulnerability and thus announces a particular risk. For example, this may be a risk associated with a particular operating system or kernel which is has been found to be vulnerable to a malware attack. The network owner may therefore wish to alter its compliance data to remove the vulnerable feature from its list of compliant attributes or features. The blockchain database may therefore be updated to take into account such a change, and thus any device subsequently evaluated against the updated compliance tree and having the newly non-compliant feature can be determined to be non-compliant, thereby protecting the network from the risk.

In addition, once a network's compliance tree is updated, the tree data structures of electronic devices registered on the distributed ledger may be evaluated to determine if any of the electronic devices are affected by the updated compliance tree of the network. For example, a device previously determined to be compliant with the network's security policy and which may still be connected to the network may subsequently be determined to be non-compliant once a compliance tree of the network is updated on the distributed ledger.

The method, particularly for use with the blockchain database, may comprise the use of smart contracts that allow for the registering and comparison of tree data structures to provide a multi-user collaboration, and the ability to verify and monitor device compliance by providing transparency of attribute and compliance data.

According to another aspect of the present disclosure, there is provided a computer program for carrying out the method according to embodiments described herein.

According to another aspect of the present disclosure, there is provided a non-transitory computer-readable medium comprising instructions for carrying out the method according to embodiments described herein.

According to another aspect of the present disclosure, there is provided a computer system for monitoring or validating compliance of attributes of a device on a network, the computer system comprising: an obtaining module configured to obtain, from a distributed ledger technology, a first tree data structure comprising compliance data associated with a network and a second tree data structure comprising attribute data associated with an electronic device; a comparison module configured to compare the first tree data structure with the second tree data structure to compare the compliance data with the attribute data; and a determining module configured to, based on the comparison by the comparison module, determine whether the electronic device is compliant with the network.

The digital ledger technology may comprise a blockchain database, and the obtaining module may be configured to obtain the first and second tree data structures by accessing a set of transactions corresponding to the first and second tree data structures from the blockchain database.

The first tree data structure may be registered with the blockchain database by creating a block in the blockchain database comprising a block hash and a root hash value of the first tree data structure. The second tree data structure may be registered with the blockchain database by the electronic device by creating a block in the blockchain database comprising a block hash and a root hash value of the second tree data structure.

The attribute data and the compliance data may comprise attributes, and if the comparison module determines that the attribute data comprises one or more attributes not in the compliance data, the determining module may be configured to determine that the electronic device is not compliant with the network.

The computer system may further comprise a mitigation module. If the determining module determines that the electronic device is not compliant with the network, the mitigation module may be configured to isolate the electronic device and determine if mitigation of the one or more attributes not in the compliance data is possible, and: if mitigation is possible, attempt mitigation of the one or more attributes not in the compliance data; or if mitigation is not possible, continue to isolate the electronic device and prevent the electronic device from accessing the network.

The mitigation module may be further configured to, if mitigation was unsuccessful, determine if further mitigation is possible, and if not, continue to isolate the electronic device and prevent the electronic device from accessing the network. If further mitigation is possible, the mitigation module may attempt the further mitigation.

The electronic device may be configured to, when isolated, attempt to reconfigure to remediate the one or more attributes not in the compliance data.

The mitigation module may be further configured to: if the attempt to reconfigure remediates the one or more attributes not in the compliance data, grant the electronic device access to the network; and if the attempt to reconfigure does not remediate the one or more attributes not in the compliance data, determine that the device is not compliant with the network.

The mitigation module may be further configured to grant the electronic device access to the network if mitigation of the one or more attributes not in the compliance data is successful.

The attribute data and the compliance data may comprise one or more attributes; and one or more of the attributes of the compliance data may be designated as essential attributes, and if the comparison determines that the attribute data does not comprise one or more of the essential attributes, the determining module may be configured to determine that the electronic device is not compliant with the network.

The first and second tree data structures may be first and second bloom trees respectively, each comprising a plurality of nodes, each node of the plurality of nodes having: an associated hash generated based on the nodes beneath it; and a probabilistic data structure for evaluating the presence or absence of one or more hashes associated with the plurality of nodes, and the comparison module may be configured to use the probabilistic data structures to evaluate the presence or absence of one or more hashes.

The obtaining module may be further configured to obtain, from the distributed ledger technology, updates to the first and/or second tree data structures; and the comparison module is further configured to perform a further comparison of the first tree data structure and the second tree data structure.

Arrangements of the present disclosure may non-exhaustively provide one or more of: publishing of compliance trees or compliance models to assist vendors developing products for an entity or organization; enforcement of compliance with security policies related to a network; management of device networks such as IoT sensor networks; detecting devices that fall out of compliance; detecting malware infected devices; the ability to efficiently verify what aspects of a device violate a policy of a network; non-repudiation and auditable tracking of compliance: a unified platform for vendor/customer device management; versatile means of specifying acceptable parameters for devices attempting to join a network; the ability to securely publish rules and requirements that vendors can evaluate against without exposing confidential details; and the ability to check changes in the behavior of a device (for example, if it is malware infected). The use of tree data structures as descriptors allows the attributes including capabilities and features of a device to be summarized conveniently, and the use of a mechanism such as a bloom filter allows efficient evaluation of such attributes.

### BRIEF DESCRIPTION OF THE DRAWINGS

The disclosure will be described in more detail, by way of example, with reference to the accompanying drawings, in which:

FIG. 1 is a schematic diagram of a tree data structure according to an aspect of the present disclosure.

FIG. 2 is a schematic diagram of a tree data structure with an electronic device according to an aspect of the present disclosure.

FIG. 3 is a schematic diagram of a fragment of a first tree data structure, a second tree data structure, and corresponding bloom filter representations according to an aspect of the present disclosure.

FIG. 4 is a schematic diagram of second tree data structure and corresponding bloom filter representation according to an aspect of the present disclosure.

FIG. 5 is a schematic diagram of bloom filter representations of a first tree data structure, a second tree data structure of a compliant electronic device, and a second tree data structure of a non-compliant electronic device according to an aspect of the present disclosure.

FIG. 6 is a block diagram of an interrogation process of an electronic device in order to build a tree data structure according to an aspect of the present disclosure.

FIG. 7 is a schematic diagram of tree data structures and electronic devices registered on the blockchain database according to an aspect of the present disclosure.

FIG. 8 is a block diagram illustrating interactions and operations with the blockchain database according to an aspect of the present disclosure.

FIG. 9a is a schematic diagram of a tree data structure of an electronic device according to an aspect of the present disclosure.

FIG. 9b is a schematic diagram of an updated tree data structure of the tree data structure of FIG. 1 according to an aspect of the present disclosure.

FIG. 9c is a schematic diagram of an updated tree data structure of the tree data structure of FIG. 9b according to an aspect of the present disclosure.

FIG. 10 is a schematic diagram of a tree data structure of a network requiring an essential attribute and a tree data structure of an electronic device according to an aspect of the present disclosure.

FIG. 11 is a block diagram illustrating the isolation and mitigation attempt of a non-compliant device following a vulnerability event according to an aspect of the present disclosure.

### DETAILED DESCRIPTION

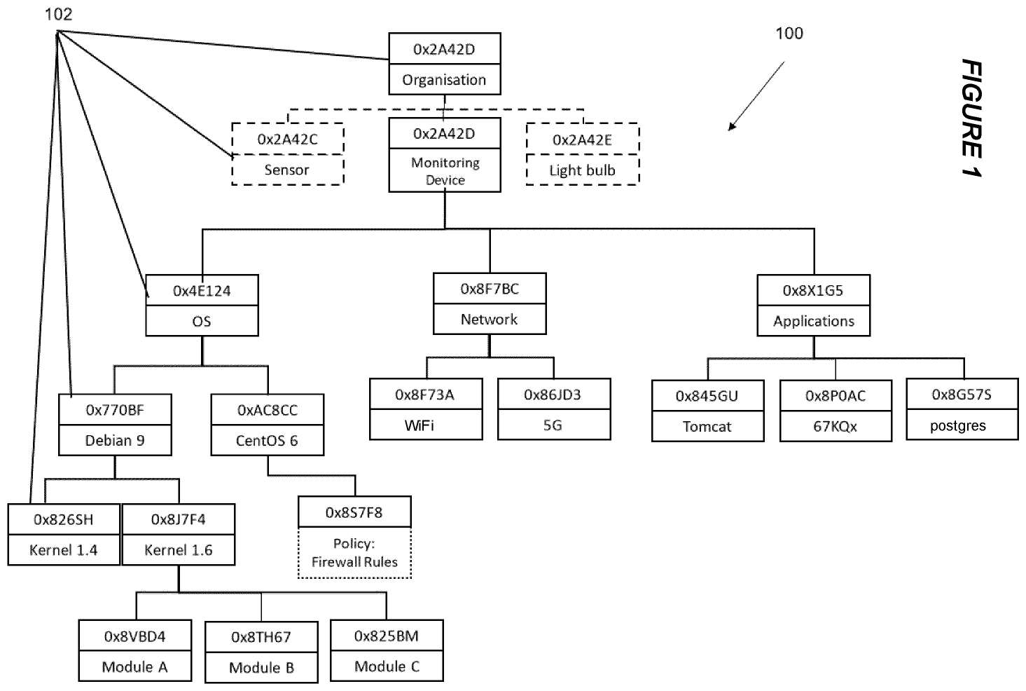

An example method and corresponding computer system for monitoring or validating compliance of attributes of an electronic device on a network will now be described with reference to FIGS. 1 to 11. Like features are denoted with like reference numerals.

FIG. 1 illustrates a first tree data structure 100. The first tree data structure 100 comprises compliance data associated with a network, which in this example belongs to, or is associated with, an organization.

In this example, the first tree data structure is a Merkle tree comprising a plurality of nodes 102. For clarity of the Figure, not every node is denoted by reference numeral 102. Each node of the plurality of nodes 102 has an associated cryptographic hash generated based on the nodes beneath it in the Merkle tree, and each cryptographic hash is different.

The nodes 102 represent the compliance data, which comprises one or more hardware and/or software attributes. Each node of the first data structure 100 represents an attribute that is accepted by the organizations network security policy. In other words, a device having all of, or a subset of, the accepted attributes described by the nodes 102 of the Merkle tree may be considered compliant and therefore be granted access to the organization's network. The nodes 102 represent all possible attributes of the compliance data accepted by the network.

The attributes may include, for example: device type, operating system, operating system version, kernel information, firewall policy, network connectivity, and applications.

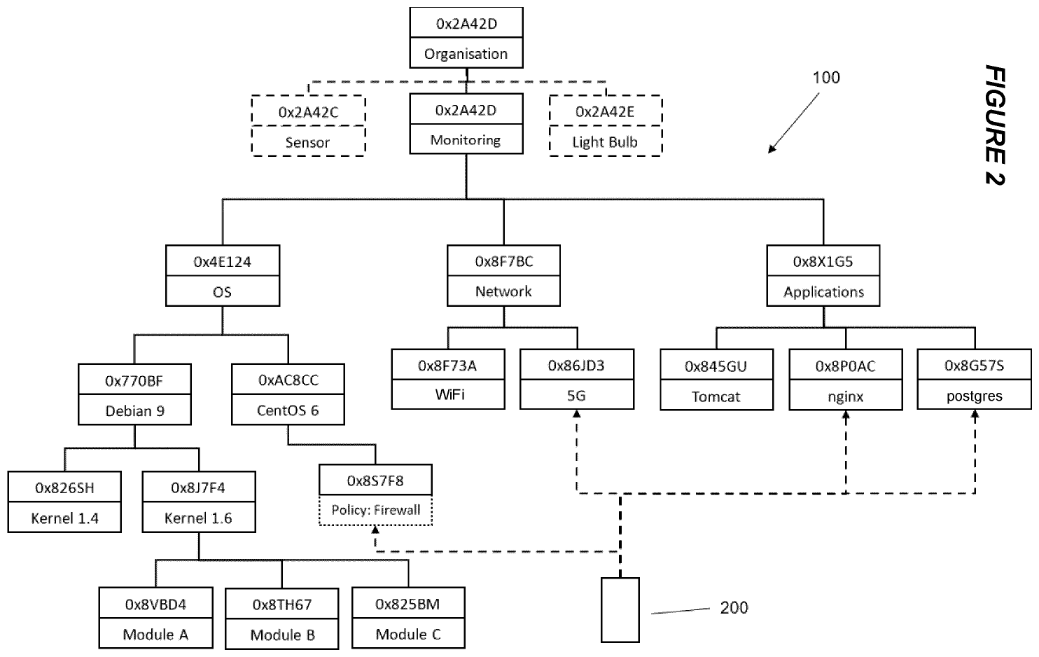

FIG. 2 similarly illustrates the first tree data structure 100 associated with the organization's network, but additionally illustrates an electronic device 200. As will be explained in more detail below with reference to figures below, the attributes of the electronic device 200 may be compared with the accepted attributes of the compliance data described in the Merkle tree to determine whether or not the electronic device is compliant with the organization's network.

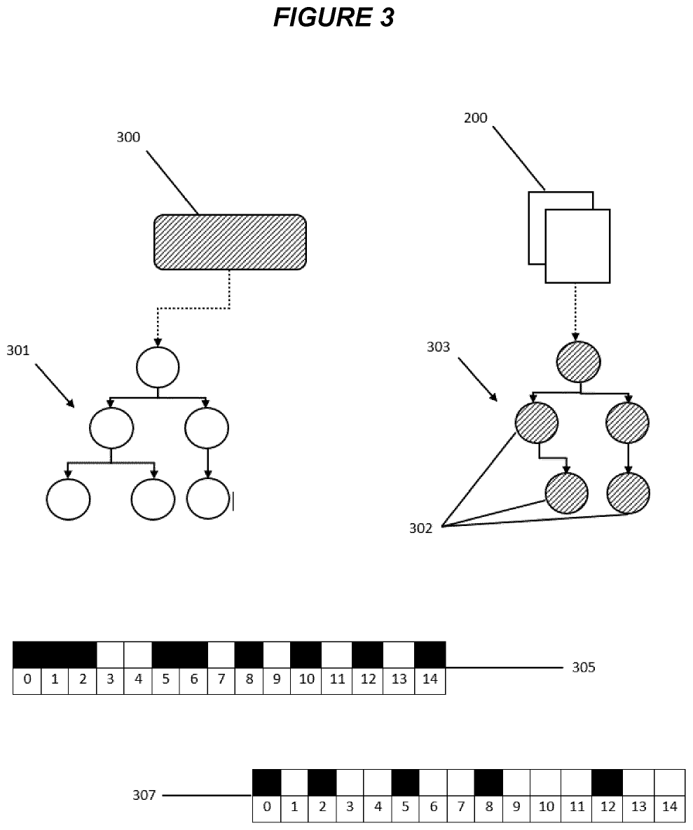

FIG. 3 illustrates a fragment or sub-portion of a first tree data structure 301 associated with the network 300, and a second tree data structure 303 associated with the electronic device 200.

The second tree data structure 303 comprises attribute data associated with an electronic device, and each node 302 of the tree data structure represents an attribute of the electronic device. Again, not all nodes are labelled for clarity.

An obtaining module of a computer system for monitoring or validating device compliance on a network obtains the first and second tree data structures.

Significantly, in this example, the first and second tree data structures (of which only a fragment or portion of the first tree data structure is shown) are bloom trees. That is, they comprise a Merkle tree structure but also comprise probabilistic data structures or bloom filters at each node of the tree structure.

A bloom filter 305 corresponding to the root node of the first tree data structure is illustrated, which conveniently summarizes the information or compliance data in the first tree data structure. Similarly, a bloom filter 307 corresponding to the root node of the second tree data structure is illustrated, which conveniently summarizes the information or trait data in the second tree data structure.

Providing the bloom filters allows for a convenient and efficient comparison of attributes associated with the electronic device and the attributes accepted by the organization's network. In this way, efficient validation or monitoring of the compliance or attributes of the electronic device can be provided.

Monitoring or validating compliance of the attributes of the device on the network comprises performing a comparison of the first tree data structure with the second tree data structure in order to compare the compliance data with the attribute data. A comparison module of the computer system performs such a comparison. Performing the comparison comprises the comparing module comparing the hashes in the second Merkle tree with the hashes in the first Merkle tree to determine if the hashes in the second Merkle tree are present in the first Merkle tree. Hence, only the relevant fragment of the first Merkle tree is illustrated and is used in the comparison.

In this example, the comparison of the compliance data and attribute data is made using the probabilistic data structures or bloom filters and particularly the bloom filters for the root nodes of the tree data structures. The bloom filters provide an evaluation mechanism for evaluating the presence or absence of one or more hashes, or one or more attributes. If the comparison determines that a hash or attribute is present in the second tree data structure associated with the electronic device that is not present in the first tree data structure, a determining module of the computer system then determines the device as being non-compliant with the organization's network.

In the embodiment illustrated, the first tree data structure 301 or compliance tree has a number of attributes considered to be accepted by the network, denoted in the illustrated bloom filter 305 in this example as bit vectors 0, 1, 2, 5, 6, 8, 10, and 12. The second tree data structure 303 describes a number of attributes associated with the electronic device, denoted in the illustrated bloom filter 307 in this example as bit vectors 0, 2, 5, 8, and 12.

In this example, as all of the attributes associated with the electronic device are present in the compliance tree of the organization's network, the electronic device is considered to be compliant, or have compliant attributes, with the organization's network and may be granted access to the network. In this example, it does not matter that the compliance tree of the organization's network has additional accepted attributes; the electronic device does not need to comprise all accepted attributes.

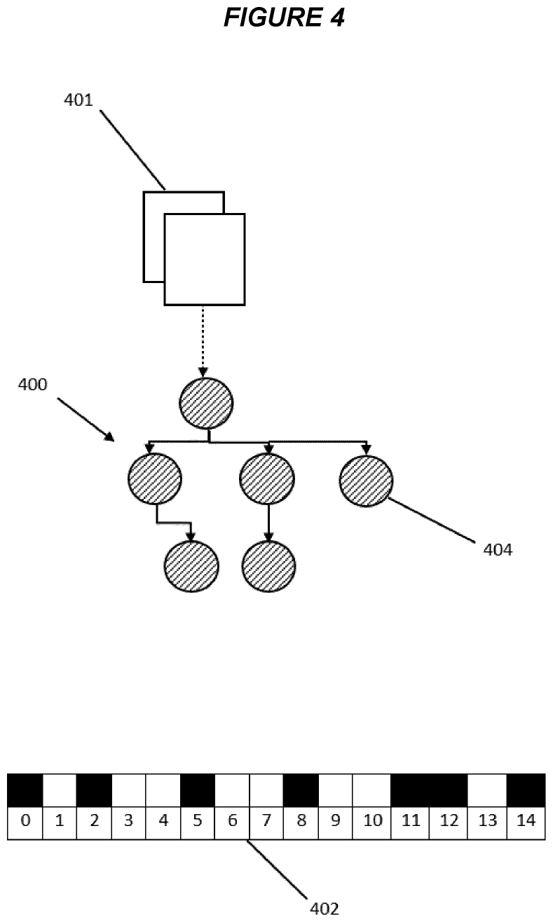

However, FIG. 4 illustrates a second tree data structure 400 associated with a different electronic device 401, together with a corresponding bloom filter representation 402 for the root node of the second tree data structure 400. In this example, the electronic device 401 has associated attributes denoted by bit vectors 0, 2, 5, 8, 11, 12, and 14 in the bloom filter.

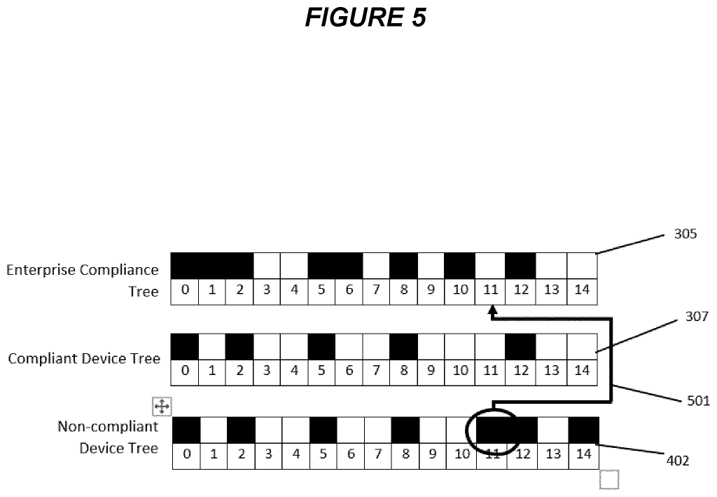

FIG. 5 illustrates a comparison between the bloom filter 305 of the first tree data structure 301 with both the bloom filter 307 of the second tree data structure 303 of the electronic device 200 and the bloom filter 402 of the second tree data structure 400 of the electronic device 401.

As established with reference to FIG. 3 above, the comparison with bloom filter 307 of the electronic device 200 results in a determination that the electronic device 200 is compliant with the organization's network.

However, significantly, second tree data structure 400 comprises a node 404 representing an attribute of the electronic device 401. In the bloom filter 402, this node is represented by bit vector 11 and is highlighted by a comparison arrow 501. The first tree data structure 301 does not include the feature associated with node 404, which is denoted by the bloom filter 305 as the bit vector 11 does not appear in the bloom filter 305. Thus, the comparison results in a determination that the electronic device 401 must have an attribute not accepted by the organization's network, or is not compliant with the organization's network. This additional node not present in the compliance tree for the organization's network results in a hash that is not a subset of the compliance tree. The electronic device 401 is thus not granted access to the network.

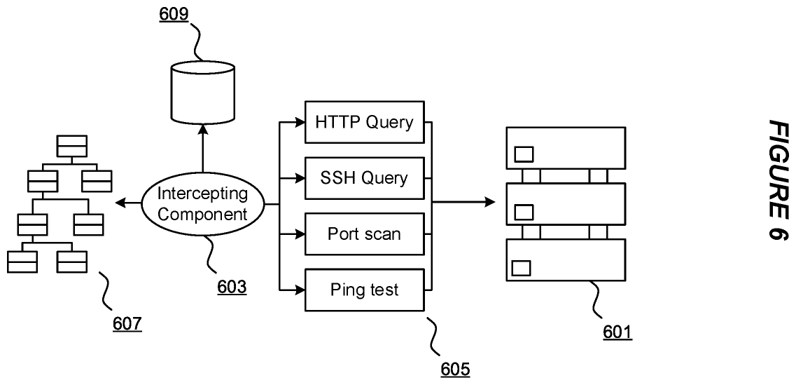

FIG. 6 illustrates the interrogation process of an electronic device 601 that is a “black box”. That is, a tree data structure associated with the electronic device 601 including the device's attribute data is not available to the network for comparison with the compliance tree. In such an example, the network must ascertain attribute data from the electronic device without being directly presented with such data.

An interrogation component 603, which in this example is part of the obtaining module (not shown) of the computer system, is configured to interrogate the electronic device 601. To do so, a plurality of requests 605 are made from the interrogation component 603 to the electronic device 601 in order to ascertain attribute data. These requests may include, for example, a HTTP query, an SSH query, a port scan, or a ping test.

The interrogation component 603 receives responses from the electronic device 601 following the requests 605 and stores the results in a database 609. This allows the computer system, and particularly the interrogation component, to build an understanding of devices which lack transparency with respect to their attribute data. The interrogation of further devices may then be expedited based on the information stored in the database 609 as an electronic device may be recognized corresponding to data stored in the database.

In addition, the received responses from the electronic device 601 are used to build or form a tree data structure 607 comprising attribute data corresponding to the “black box” electronic device 601. A bloom tree structure is formed and may then be used for comparison with a network compliance tree in the manner described above to validate or monitor compliance of attributes of the “black box” electronic device 601 with the organization's network.

The compliance trees may be published by an organization, for example on a digital ledger technology such as the blockchain ecosystem. Advantageously, the compliance tree does not expose the details of the organization's security policy directly, but allows the validation or monitoring of attributes of a device to determine their compliance with the network.

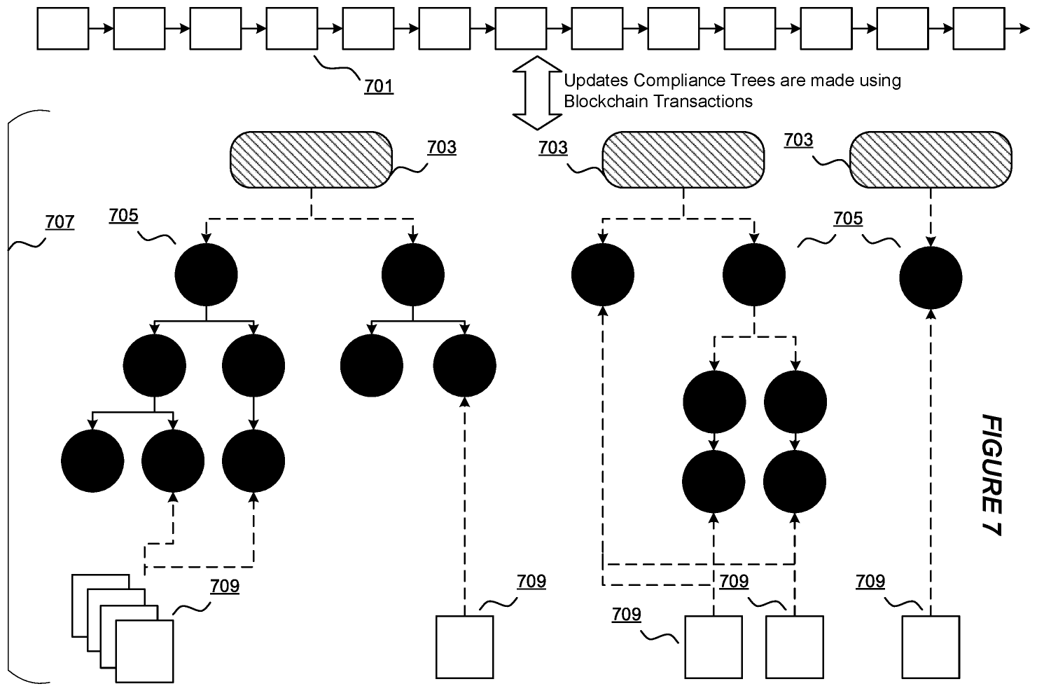

FIG. 7 illustrates compliance trees and electronic devices registered to the blockchain database. The blocks 701 of the blockchain record compliance trees describing network policy information and device information, and the blockchain can be updated to record any changes made. Registering a tree data structure with a block comprises creating a block in the blockchain database comprising a block hash and a root hash value of the tree data structures.

Networks 703 publish or register their compliance trees 705 with the blockchain database. These compliance trees 705 exist on a tree shaped ledger 707 that can be constantly updated to record any changes made to the compliance trees 705. Each network 703 may provide one or more of its own compliance tree 705 or may use one or more compliance trees published by other network owners or enterprises.

The ledger 707 also comprises information of electronic devices 709. In particular, compliance trees of the devices 709 are stored on the blockchain database via blocks 701, along with determinations whether the electronic devices 709 are compliant with compliance trees 705 of particular networks 703. The electronic devices 709 may register themselves against nodes of the network compliance trees showing proof of attributes through evaluation of hashes to demonstrate their compliance. That is, they may sign against the hashes in the compliance trees 705 which match hashes in their own tree data structures. Advantageously, the tree data structures and thus the blockchain do not directly expose details of policies.

The comparison of compliance trees to validate or monitor compliance of attributes is similar to that described above in relation to FIGS. 3 to 5 but includes obtaining the first and second tree data structures from the blockchain database. Tree structures may be obtained for a plurality of devices 709 to determine compliance with a particular network 703, or a plurality of network tree data structures may also be obtained to determine compliance of a plurality of devices 709 across a plurality of networks 703. In this example, the comparison comprises determining which hashes the electronic devices 709 have signed against to determine attributes present in the attribute data of the devices.

In this example, a network owner provides its own network compliance tree directly to the distributed ledger system. Similarly, the electronic device provides its compliance tree to the distributed ledger system and signs against relevant hashes when requesting access to a network 703. Advantageously, once registered to the blockchain database, there is a record of attributes of the device even if the device goes offline or disconnects from the network.

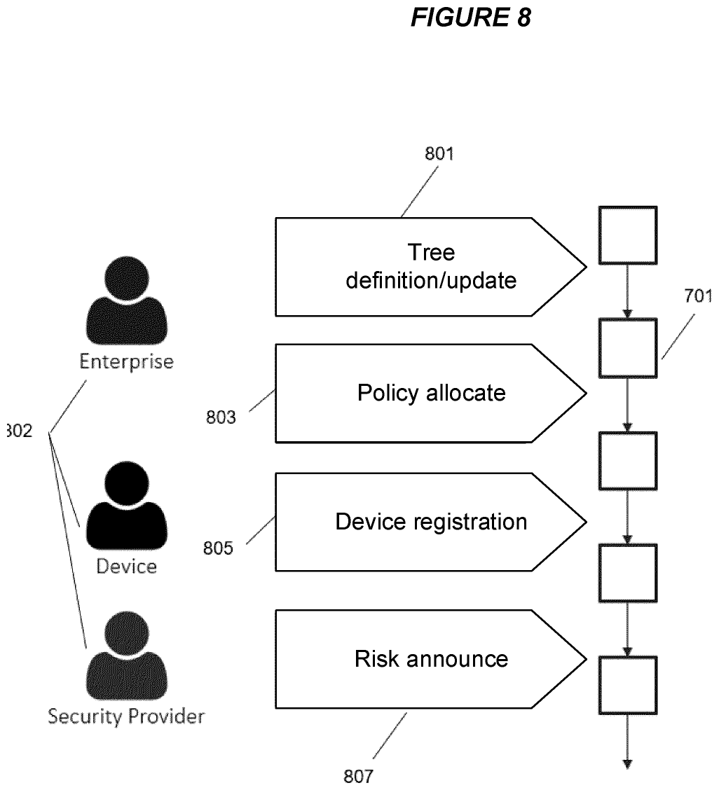

FIG. 8 is a block diagram illustrating potential interactions or operations with the blockchain database.

There are a number of expected interactions or operations that enable different users or entities 802 to interact within the blockchain ecosystem. These may include a tree definition or update 801, allowing an enterprise or organization to specify compliance requirements for different device categories with tree data structures. At this interaction, the network owner provides one or more compliance trees which may correspond to hardware and/or software requirements, each of which may be different for various types of device.

The interactions also include allocation of policy 803. This allows organizations to define policies or restrictions that would apply to a fragment of a compliance tree. As an example, if a new vulnerability is discovered affecting an SSH server, then restrictions on connections to port 22 may be applied.

The interactions also include device registration 805 to allow devices to register themselves against a compliance tree, verifying that they are compliant, and subsequently gaining access to a target network. The comparison of compliance trees may be made as described above to verify compliance. Steps may also be taken by the network owner to ensure compliance is satisfactory.

The interactions also include risk announcement 807 in which third-party security vendors may release vulnerability information that is then used by an organization to update their compliance trees or policies.

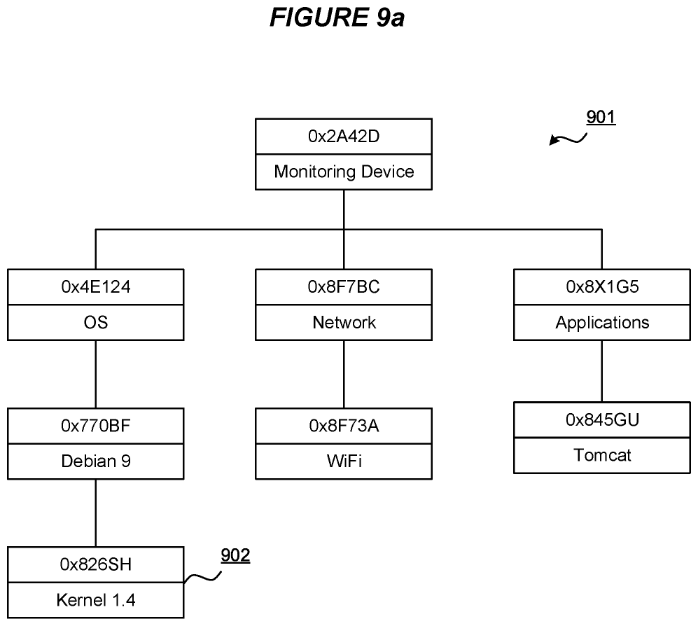

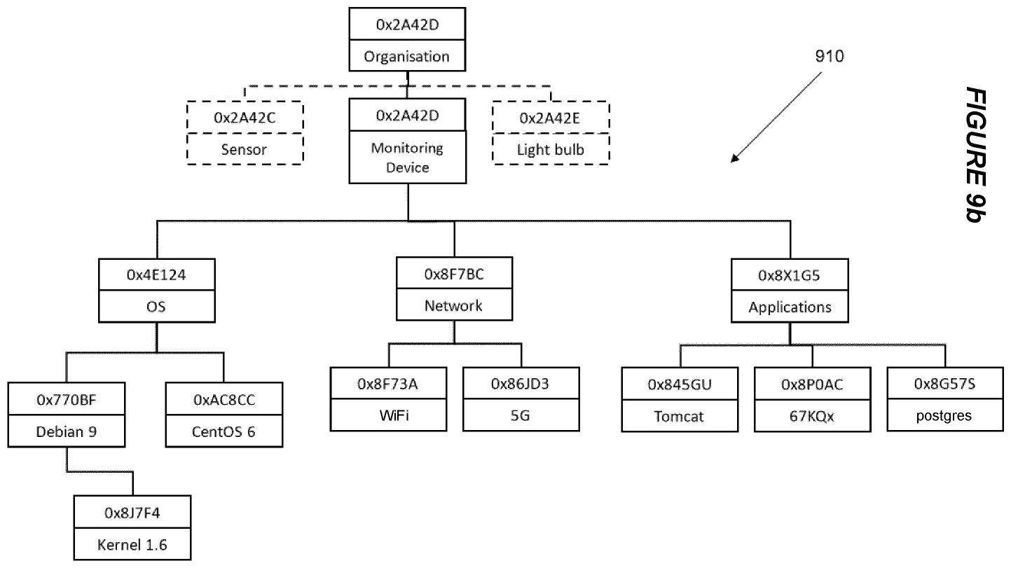

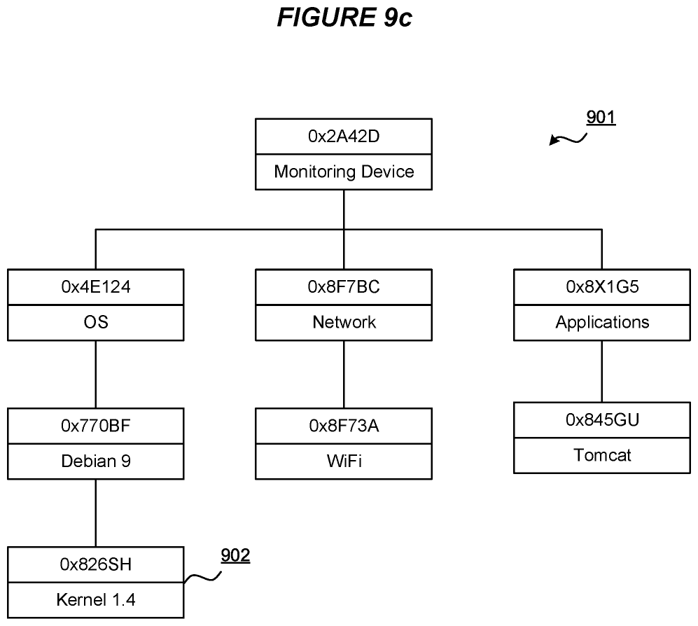

An example risk announcement is described in relation to FIGS. 9a to 9c.

FIG. 9a illustrates a compliance tree 901 for an electronic device. In this example, the compliance tree is a bloom tree comprising attribute data of the electronic device. Each node of the tree structure describes an attribute of the attribute data. The compliance tree 901 can be compared to a network's compliance tree to determine its compliance with the network.

The compliance tree 100 of FIG. 1 was previously described as a Merkle tree, but in this example, the compliance tree 100 is a bloom tree. Taking the compliance tree 100 as an example, the compliance tree 901 of the electronic device comprises only attributes contained within the compliance data in the compliance tree 100 and thus would be determined to be compliant with the network.

However, a risk announcement provided by a third party to the blockchain database indicates that kernel 1.4 at node 902 is vulnerable to a security threat. Therefore, illustrated in compliance tree 910 of FIG. 9b, the network of compliance tree 100 removes kernel 1.4 as a compliant attribute from its compliance data.

The change to the compliance tree is updated in the blockchain database, and compliance trees of devices on the blockchain database are evaluated to determine if they are affected by the change. In the case of compliance tree 901, node 902 is no longer present in the compliance tree 910 and thus the device is determined to be non-compliant. The device may therefore be denied access to the network, or have its access revoked if it is currently connected to the network.

It is known which attribute of the device has been found to be non-compliant. Therefore, the device can attempt to reconfigure to become compliant. In this example, the device could upgrade its kernel version to 1.6, which is present in compliance tree 910, and thus become compliant.

Significantly, all of these changes are tracked against the blockchain so all parties can track visibility. As all parties are aware of the non-compliant feature, various parties can make interventions to reconfigure, change, or overcome the non-compliance in order to grant the device access.

In another example, if a specific port is announced to be vulnerable and is thus removed from the compliance data, the network can reconfigure its firewall to block that port. Advantageously, it is known from the blockchain database which devices have that port, so the risk can be easily mitigated. The blockchain publication allows the automatic response to vulnerabilities as changes can be tracked, and devices which need to be reconfigured in response to the changes can also be tracked. That is, the devices having their tree data structures registered on the blockchain means devices affected by changes can be easily identified.

In previously described embodiments, to be considered compliant, an electronic device merely needed its attributes to be in the compliance data of the network, and did not necessarily require particular attributes. However, in some embodiments, a network, and the compliance tree of a network, may designate one or more attributes of the compliance data as being essential attributes or essential nodes of the tree data structure. For example, to be considered compliant, a device may be required to have kernel 1.6. In order to determine a device as being compliant, the electronic device must have the essential attributes. This may require the use of multiple hashes, a bloom filter, or may require a specific hash.

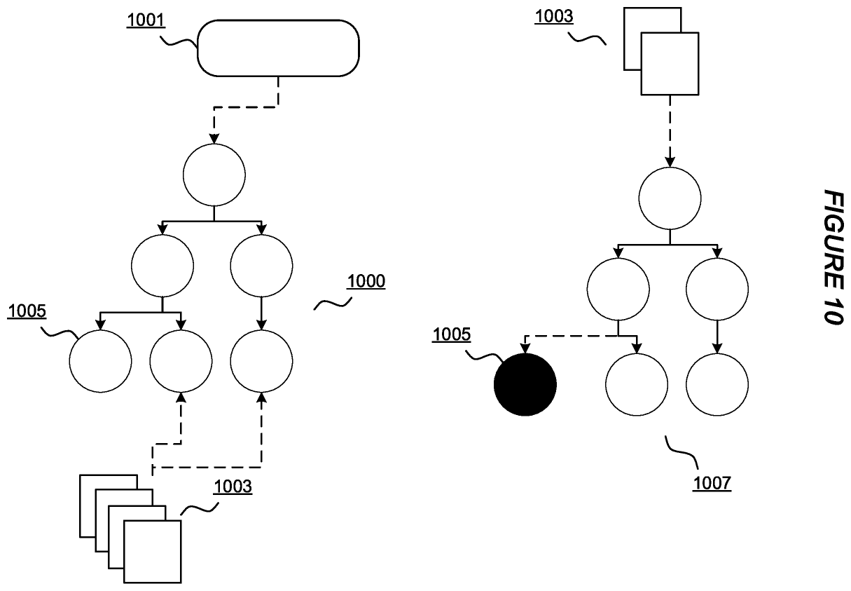

FIG. 10 illustrates a compliance tree 1000 of a network 1001. Compliant devices 1003 are currently connected to the network and are compliant (they only comprise attributes in the compliance data of the network 1001).

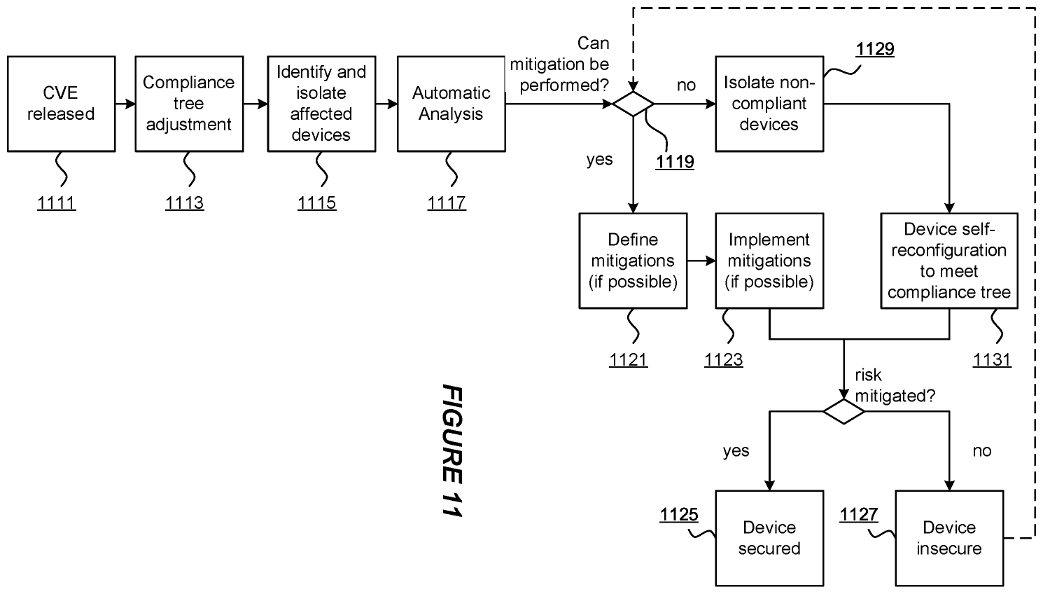

However, the attribute corresponding to node 1005 is then designated as essential. The attribute data in the compliance tree 1007 of initially compliant devices 1003 does not comprise the essential attribute of node 1005. Therefore, in order to be considered compliant with the network 1001, the existing devices 1003 must reconfigure to comprise the attribute of essential node 1005. Such reconfiguration is discussed more in relation to FIG. 11 below. In addition, any other device wishing to connect to the network 1001 must have the essential attribute in order to be considered compliant.

If a device lacks an essential feature, the consequence may be more strict than if a device has an additional attribute not in the compliance data.

FIG. 11 is a block diagram illustrating occurrence of a vulnerability event, and the isolation and attempted mitigation of a non-compliant electronic device.

When an event occurs, such as a new compliance vulnerability event (CVE) being released 1111, the relevant compliance tree is updated and the blockchain is updated accordingly 1113. The organization or network must assess which sub-fragments of compliance trees are affected. Conveniently, as the compliance trees of both the network and the electronic devices are registered to the blockchain, devices affected by the change can easily be identified and are isolated from the network 1115. That is, they are held in a state in which compliance may be evaluated, but are not granted access to the network.

Automatic analysis 1117 to identify remediations or mitigations (such as changes to network policy) is carried out. If it is determined that mitigation is possible 1119, then the mitigations are identified 1121 and attempted 1123. For example, where a certain port or remote server may be found to be non-compliant, the network or enterprise itself may be able to take action to mitigate these attributes such as reconfiguration of a firewall.

If the mitigation is successful and the one or more attributes not in the compliance data are mitigated, then the device is determined as being secure and is granted access to the network 1125.

However, if mitigation is unsuccessful 1127, the device is determined as still being non-compliant, or as being non-secure, and it is again determined whether further mitigation is possible 1119.

If it is determined at any stage that no mitigation is possible, the electronic device is isolated 1129. At this stage, the electronic device can attempt to reconfigure 1131 to remediate the one or more attributes not in the compliance data. The electronic device may be instructed to reconfigure, including being instructed with one or more actions to perform to reconfigure, by the network or a computer system of the network. If the reconfiguration is successful at remediating or mitigating the attributes not in the compliance data, the device is determined to be secure and is granted access to the network 1125. If the reconfiguration is unsuccessful at remediating or mitigating the attributes not in the compliance data, the device is determined to be non-compliant 1127 and may either be denied access to the network entirely, or further mitigation or reconfiguration may be attempted.

Embodiments of the disclosure have been described. It will be appreciated that variations and modifications may be made to the described embodiments within the scope of the present claims.

1. A method for monitoring or validating compliance of attributes of a device on a network, the method comprising:
obtaining, from a distributed ledger technology, a first tree data structure comprising compliance data associated with a network, and a second tree data structure comprising attribute data associated with an electronic device;
comparing the first tree data structure with the second tree data structure to compare the compliance data with the attribute data; and
determining, based on the comparison, whether the electronic device is compliant with the network.

2. The method according to claim 1, wherein the distributed ledger technology comprises a blockchain database, and the obtaining comprises accessing a set of transactions corresponding to the first tree data structure and the second tree data structure from the blockchain database.

3. The method according to claim 2, further comprising registering the first tree data structure with the blockchain database, the registering comprising creating a block in the blockchain database comprising a block hash and a root hash value of the first tree data structure.

4. The method according to claim 2, further comprising the electronic device registering the second tree data structure with the blockchain database, the registering comprising creating a block in the blockchain database comprising a block hash and a root hash value of the second tree data structure.

5. The method according to claim 1, wherein the attribute data and the compliance data comprise attributes, and the method further comprises, if the comparing determines that the attribute data comprises one or more attributes not in the compliance data, determining that the electronic device is not compliant with the network.

6. The method according to claim 5, further comprising, if the electronic device is determined to be not compliant with the network, isolating the electronic device and determining if mitigation of the one or more attributes not in the compliance data is possible, and:
if mitigation is possible, attempting mitigation of the one or more attributes not in the compliance data; or
if mitigation is not possible, continuing to isolate the electronic device and preventing the electronic device from accessing the network.

7. The method according to claim 6, further comprising, after attempting mitigation, if mitigation was unsuccessful, determining if further mitigation is possible, and if not, continuing to isolate the electronic device and preventing the electronic device from accessing the network.

8. The method according to claim 6, wherein when the electronic device is isolated, the method further comprises the electronic device attempting to reconfigure to remediate the one or more attributes not in the compliance data.

9. The method according to claim 8, wherein:
if the attempt to reconfigure remediates the one or more attributes not in the compliance data, the method further comprises granting the electronic device access to the network; and
if the attempt to reconfigure does not remediate the one or more attributes not in the compliance data, the method further comprises determining that the device is not compliant with the network.

10. The method according to claim 6, further comprising:
if mitigation of the one or more attributes not in the compliance data is successful, granting the electronic device access to the network.

11. The method according to claim 1, wherein the attribute data and the compliance data comprise one or more attributes, and the method further comprises:
designating one or more of the attributes of the compliance data as essential attributes; and
if it is determined that the attribute data does not comprise one or more of the essential attributes, determining that the electronic device is not compliant with the network.

12. The method according to claim 1, wherein the first tree data structure is a first bloom tree and the second tree data structure is a second bloom tree, each of the first bloom tree and the second bloom tree comprising a plurality of nodes, each node of the plurality of nodes having: an associated hash generated based on the nodes beneath that respective node; and a probabilistic data structure for evaluating a presence or an absence of one or more hashes associated with the plurality of nodes, the method further comprising using the probabilistic data structures to evaluate the presence or the absence of one or more hashes.

13. The method according to claim 1, further comprising:
updating at least one of the first tree data structure or the second tree data structure to provide at least one of updated compliance data or updated attribute data, respectively;
updating the distributed ledger technology with the updated compliance data or the updated attribute data; and
performing a further comparison of the first tree data structure with the second tree data structure.

14. A computer system comprising at least one processor and memory for carrying out the method of claim 1.

15. A computer system for monitoring or validating compliance of attributes of a device on a network, the computer system comprising:
an obtaining module configured to obtain, from a distributed ledger technology, a first tree data structure comprising compliance data associated with a network and a second tree data structure comprising attribute data associated with an electronic device;
a comparison module configured to compare the first tree data structure with the second tree data structure to compare the compliance data with the attribute data; and
a determining module configured to, based on the comparison by the comparison module, determine whether the electronic device is compliant with the network.
